(19) United States
(12) Patent Application Publication
(10) Pub. No.: US 2003/0026750 A1
(43) Pub. Date: Feb. 6, 2003

(54) Conversion of low NOx concentrations in combustion gases to nitric acid or fertilizer using hydrogen peroxide and lye

(76) Inventor: Vincent Roy Page, Katy, TX (US)

Correspondence Address: NIXON & VANDERHYE P.C., 8th Floor, 1100 North Glebe Rd., Arlington, VA, 22201-4714, US

(21) Appl. No.: 09/920,800

(22) Filed: Aug. 3, 2001

(51) Int. Cl. B01D 53/56

(52) U.S. Cl. 423/235

(57) ABSTRACT

A process for reducing NOₓ emissions in a gaseous combustion effluent stream containing NO and/or NO₂ includes the steps of: a) adding hydrogen peroxide to the effluent stream in sufficient amounts to generate nitric acid by first stage reactions as follows:

2NO+H₂O₂+O₂→2HNO₃

2NO₂+H₂O₂→2HNO₃

2NO+2NO₂+O₂+2H₂O₂→4HNO₃;

and optionally, after the nitric acid is generated, adding sufficient amounts of potassium hydroxide to the effluent stream to generate potassium nitrate in second stage reactions as follows:

2HNO₃+2KOH→2KNO₃+2H₂O

4HNO₃+4KOH→4KNO₃+4H₂O.

### BACKGROUND OF THE INVENTION

This invention relates to a new NOₓ emissions reduction technique for combustion gases that converts oxides of nitrogen to commercial nitric acid or agricultural grade fertilizer.

Oxides of nitrogen are produced as a result of any process utilizing air for combustion due to the high concentration of nitrogen in air. Existing techniques for reducing oxides of nitrogen in an exhaust gas stream of, for example, a land-based gas turbine, involve the use of ammonia in a catalyzing process. The reactions are as follows:

4NO+4NH₃+O₂→4N₂+6H₂O

6NO₂+8NH₃→7N₂+12H₂O

NO+NO₂+2NH₃→2N₂+3H₂O.

Ammonia carryover, when it occurs, results in nitrous-amine emissions into the atmosphere, emissions that are alleged to be carcinogenic. As a result, public pressure to use something other than ammonia for NOₓ reduction is mounting and should lead to increased demand for other NOₓ reduction techniques.

It is known to first convert gaseous streams containing oxides of nitrogen to aqueous streams before further processing with hydrogen peroxide. This is extremely undesirable for combustion processes, however, due to the large amount of combustion effluent produced. The required aqueous water beds would be large, unwieldy and most likely unworkable due to high exhaust gas flow rates and low dwell times. See, for example, U.S. Pat. No. 6,039,783.

It is also known to use hydrogen peroxide in dilute form or in low percentages by weight, sometimes combined with other reactants, to reduce extremely high NOₓ concentrations (>1000 ppm) to lower concentrations, but not lower than 100 ppm. See, for example, U.S. Pat. No. 5,637,282.

### BRIEF SUMMARY OF THE INVENTION

This invention reduces oxides of nitrogen from an already low-NOₓ level (<400 ppm) to an extremely low level (<40 ppm), utilizing hydrogen peroxide in a first-stage reaction and, optionally, potassium hydroxide, or lye, in a second-stage reaction. The by-product of the first stage reaction is nitric acid, which can either be sold as the desired by-product, or reduced further to potassium nitrate (i.e., fertilizer that is suitable for use in commercial or agricultural applications) in a second-stage reaction with lye. In the preferred arrangement, hydrogen peroxide is added to the exhaust gas stream as an aerosol, while potassium hydroxide is subsequently added in particulate form.

Accordingly, in its broader aspects, the invention relates to a process for reducing NOₓ emissions in a gaseous combustion effluent stream containing nitric oxide (NO) and/or nitrogen dioxide (NO₂) comprising a) adding hydrogen peroxide to the effluent stream in sufficient amounts to generate nitric acid by first stage reactions as follows:

2NO+H₂O₂+O₂→2HNO₃

2NO₂+H₂O_{2→}2HNO₃

2NO+2NO₂+O₂+2H₂O₂→4HNO₃.

In another aspect, the invention relates to a process for reducing NOₓ emissions in a gaseous combustion effluent stream containing NO and/or NO₂ comprising the steps of:

a) adding hydrogen peroxide in aerosol form to the effluent stream in sufficient amounts to generate nitric acid by first stage reactions as follows:

2NO+H₂O₂+O₂→2HNO₃

2NO₂+H₂O₂→2HNO₃

2NO+2NO₂+O₂+2H₂O₂→4HNO₃; and thereafter

b) adding sufficient potassium hydroxide in particulate form to the stream to generate potassium nitrate in second stage reactions as follows:

2HNO₃+2KOH→2KNO₃+2H₂O

4HNO₃+4KOH→4KNO₃+4H₂O.

In still another aspect, the invention relates to a process for reducing NOₓ emissions in a gaseous combustion effluent stream from a land-based gas turbine containing NO and/or NO₂ comprising the steps of:

a) adding hydrogen peroxide to the effluent stream in sufficient amounts to generate nitric acid by first stage reactions as follows:

2NO+H₂O₂+O₂→2HNO₃

2NO₂+H₂O₂→2HNO₃

2NO+2NO₂+O₂+2H₂O₂→4HNO₃; and thereafter

b) adding sufficient potassium hydroxide to the stream to generate potassium nitrate in second stage reactions as follows:

2HNO₃+2KOH→2KNO₃+2H₂O

4HNO₃+4KOH→4KNO₃+4H₂O.

### DETAILED DESCRIPTION OF THE INVENTION

Oxides of nitrogen exist as two major compounds in combustion effluent, i.e., exhaust gas. At high temperatures, they exist as nitric oxide (NO), but as temperatures approach ambient either in the exhaust effluent stream itself, or after the exhaust is admitted to the atmosphere, the NO tends to bond with free oxygen to produce nitrogen dioxide (NO₂). The higher-order compounds that can also be created (NO₃, NO₄, etc.) exist only in negligible quantities, and are not of particular concern here. The reactions that pertain to this invention occur in one or two stages, depending upon the desired by-product. The first stage is a reaction with hydrogen peroxide preferably added to the exhaust gas stream as an aerosol, causing the following reactions:

2NO+H₂O₂+O₂→2HNO₃

2NO₂+H₂O₂→2HNO₃

2NO+2NO₂+O₂+2H₂O₂→4HNO₃.

As can be seen from the equations, hydrogen peroxide may be required in a near-full-strength condition and as a significant weight percentage in proportion to the oxides of nitrogen. The by-product of this first stage reaction is nitric acid (HNO₃) which can be utilized as a saleable product, or which can be converted to potassium nitrate (KNO₃), i.e., fertilizer, by the addition of potassium hydroxide (KOH), or lye, in a second-stage reaction as follows:

2HNO₃+2KOH→2KNO₃+2H₂O

4HNO₃+4KOH→4KNO₃+4H₂O.

It will be appreciated by those of ordinary skill that for particular applications, various process parameters need to be determined, such as:

1) The best method to meter the correct amounts of hydrogen peroxide, a liquid, potassium hydroxide, a solid, into the exhaust gas stream;

2) The most efficient method for admitting hydrogen peroxide and potassium hydroxide to the exhaust gas path, including but not limited to optimum aerosol size for hydrogen peroxide, optimum particulate size for potassium hydroxide, optimum catalyst matrix size and most cost-effective catalyst matrix material;

3) The time required for complete conversion to nitric acid before adding potassium hydroxide. If the hydrogen peroxide and potassium hydroxide are added at the same time, potassium dioxide (a solid) can form. In addition, free hydrogen is liberated. The chemical equation for the reaction is:

KOH+H₂O₂→KO₂+H₂O+H;

4) The temperature range in which the reactions will occur. If the applicable temperature range is outside the normal range of exhaust gas temperatures, the temperature can be adjusted to the desired range in a waste heat recovery boiler, prior to (or at the same time as) the introduction of the hydrogen peroxide and/or the potassium hydroxide.

5) The resulting properties for nitric acid and potassium nitrate, as determined by small scale lab tests;

6) Selection of filters that will remove nitric acid and potassium nitrate from the exhaust gas path;

7) Evaluation of NOₓ reduction efficiencies for compliance with design goals and EPA requirements;

8) Evaluation of nitric acid and potassium nitrate removal efficiencies for compliance with design goals and EPA requirements; and

9) Safe material handling procedures for hydrogen peroxide and potassium hydroxide during every phase of the process.

It will be appreciated that the process of this invention can be utilized in any gaseous combustion effluent stream, including those relating to stationary internal combustion engines, reciprocating engines, gas turbines, heaters, boilers, and other devices that utilize the combustion process or combustion gases in their operation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for reducing NOₓ emissions in a gaseous combustion effluent stream containing NO and/or NO₂ comprising:
a) adding hydrogen peroxide to the effluent stream in sufficient amounts to generate nitric acid by first stage reactions as follows:
2NO+H₂O₂+O₂→2HNO₃
2NO₂+H₂O₂→2HNO₃
2NO+2NO₂+O₂+2H₂O₂→4HNO₃.

2. The process of claim 1 and further comprising, after nitric acid is generated, sufficient amounts of potassium hydroxide are added to the effluent stream to generate potassium nitrate in second stage reactions as follows:
2HNO₃+2KOH→2KNO₃+2H₂O
4HNO₃+4KOH→4KNO₃+4H₂O.

3. The process of claim 1 wherein the hydrogen peroxide is added in aerosol form.

4. The process of claim 2 wherein the potassium hydroxide is added in particulate form.

5. The process of claim 1 wherein NOₓ emissions are reduced to a level below 40 ppm.

6. A process for reducing NOₓ emissions in a gaseous combustion effluent stream containing NO and/or NO₂ comprising the steps of:
a) adding hydrogen peroxide in aerosol form to the effluent stream in sufficient amounts to generate nitric acid by first stage reactions as follows:
2NO+H₂O₂+O₂→2HNO₃
2NO₂+H₂O₂→2HNO₃
2NO+2NO₂+O₂+2H₂O₂→4HNO₃; and thereafter
b) adding sufficient potassium hydroxide in particulate form to the stream to generate potassium nitrate in second stage reactions as follows:
2HNO₃+2KOH→2KNO₃+2H₂O
4HNO₃+4KOH→4KNO₃+4H₂O.

7. The process of claim 6 wherein NOₓ emissions are reduced to a level below 40 ppm.

8. A process for reducing NOₓ emissions in a gaseous combustion effluent stream from a land-based gas turbine containing NO and/or NO₂ comprising the steps of:
a) adding hydrogen peroxide to the effluent stream in sufficient amounts to generate nitric acid by first stage reactions as follows:
2NO+H₂O₂+O₂→2HNO₃
2NO₂+H₂O₂→2HNO₃
2NO+2NO₂+O₂+2H₂O₂→4HNO₃; and thereafter
b) adding sufficient potassium hydroxide to the stream to generate potassium nitrate in second stage reactions as follows:
2HNO₃+2KOH→2KNO₃+2H₂O
4HNO₃+4KOH→4KNO₃+4H₂O.

9. The process of claim 8 wherein the hydrogen peroxide is added in aerosol form.

10. The process of claim 8 wherein the potassium hydroxide is added in particulate form.

11. The process of claim 8 wherein NOₓ emissions are reduced to a level below 40 ppm.
